(19) United States
(12) Patent Application Publication
(10) Pub. No.: US 2005/0120971 A1
(43) Pub. Date: Jun. 9, 2005

(54) Retractable barrel for equestrian training and competition

(76) Inventor: James L. Fuller, Pittsburg, TX (US)

Correspondence Address: Ronald B. Sefrna;Sefrna & Associates, P.O. Box 567, Tyler, TX, 75710-0567, US

(21) Appl. No.: 10/713,368

(22) Filed: Nov. 14, 2003

(51) Int. Cl. A01K 15/02

(52) U.S. Cl. 119/705

(57) ABSTRACT

A retractable barrel apparatus includes a stable base to rest upon the ground, an upright support member flexibly connected to the base, a cover support connected to the support member, and a flexible generally cylindrical cover disposed over the cover support with the wall of the cover extending to the ground surrounding the cover support, support member, and base, to replicate the size and shape of a conventional rigid barrel commonly used in barrel racing. The flexible connection between the support member and the base allows the cover support and support member to readily move laterally away from an impact by a horse and rider, substantially reducing the risk of injury to horse and/or rider.

### FIELD OF THE INVENTION

The present invention generally relates to apparatus for use in equestrian training and competition, and in its preferred embodiments more specifically relates to a retractable, collapsible structure for the protection of horses and riders engaging in barrel racing.

### BACKGROUND OF THE INVENTION

Cloverleaf barrel racing is a very popular event in rodeos and horse shows, and draws participants including both amateur and professional riders. In the event a horse and rider must negotiate a generally triangular course laid out with a barrel positioned at each point of a triangle. Each horse and rider must circle each barrel, beginning with one of the barrels on the baseline of the triangle, followed by the next baseline barrel, and then the barrel at the apex, and then across a finish line positioned “below” the base of the triangular configuration. The event is a timed event, and the participant who completes the course in the shortest time, without upsetting a barrel, is the winner. If a horse knocks over a barrel a time penalty is assessed or, under some rules, the participant may be disqualified. It is, therefore, an important aspect of the event for the horse and rider to circle each barrel as closely as possible without knocking over any of the barrels.

The barrels used in the event must meet certain requirements, and are almost always empty fifty-five gallon metal drums, set on end. Although these barrels can be readily knocked over by a horse, they are very rigid structures of substantial weight, and an impact with a barrel at racing speed can not only be very painful, but potentially injurious to the rider, the horse, or both. A horse can also knock a barrel into its path and lose its footing, resulting in a very dangerous fall. A rider can also fall from the horse onto a barrel and sustain serious injury. The exposure to these risks is exacerbated by the fact that successful training of a barrel racing horse requires a great deal of practice, involving running the barrel pattern over and over.

There is a need for a barrel apparatus of the same size and configuration as the “regulation” barrels used in barrel racing, without the risks of injury to horses and to riders posed by the use of heavy, rigid barrels known in the prior art for training and in competition.

### SUMMARY OF THE INVENTION

The present invention substantially eliminates the risks to horses and riders that are inherent with the use of heavy rigid barrels. The invention provides an apparatus that is configured in the same size and shape as a typical, or “regulation” barrel, but is constructed to retract or collapse under impact and then return to its original configuration. In the preferred embodiment the apparatus includes a stable base to rest upon the ground, an upright support member flexibly connected to the base, a cover support connected to the support member, and a flexible cover of generally the same shape and size as a conventional barrel. The cover is formed as a hollow cylinder of, e.g., sturdy canvas or other suitably flexible material, closed at the top and open at the bottom so that it can be easily placed over the cover support. The top of the cover and the cover support are of the same diameter so that the top of the cover extends fully over the cover support and the sides of the cover hang to the ground, replicating the shape of a conventional barrel.

The flexible connection between the support member and the base allows the cover support and support member to readily move laterally away from an impact, unlike a rigid conventional barrel. The combined weight of the cover, cover support, and support member is much less than the weight of a conventional barrel, and the inertial resistance to movement in response to an impact is correspondingly less. Accordingly, the effect of an impact with the barrel apparatus of the invention on a horse and/or rider is substantially reduced in comparison to a conventional barrel, with a corresponding reduction in the risk of injury.

In an alternative embodiment of the invention suitable for use in competition, a tilt indicator means is included, to signal to officials and timekeepers that a horse and rider have deflected the apparatus sufficiently to have knocked over a conventional barrel. The tilt indicator means may be used to provide a visual signal, an audible signal, an electronic signal to a timing device, or a combination of signals.

The structure and features of the preferred and alternative embodiments of the retractable barrel of the invention will be described with reference to the accompanying drawing figures.

### BRIEF DESCRIPTION OF THE DRAWINGS

FIG. 1 is a side elevation view of the retractable barrel of the invention, with the cover in place.

FIG. 2 is a top plan view of the retractable barrel of the invention, with the cover in place.

FIG. 3 is a side elevation view of the internal support assembly of the preferred embodiment of the retractable barrel of the invention, without the cover.

FIG. 4 is a top plan view of the preferred embodiment of the base component of the support assembly.

FIG. 5 is a sectioned side elevation view of the preferred embodiment of the base component of the support assembly, along line 5-5 of FIG. 4.

FIG. 6 is a side elevation view of the preferred embodiment of the central support member of the support assembly.

FIG. 7 is a side elevation view of an alternative embodiment of the central support member of the support assembly.

FIG. 8 is a top plan view of an alternative embodiment of the cover support component of the support assembly.

FIG. 9 is a side elevation view of the alternative embodiment of the cover support component of FIG. 8.

FIG. 10 is a side elevation view of the support assembly of an alternative competition embodiment of the invention.

FIG. 11 is a side elevation view of a portion of the sensing and signaling means of the alternative competition embodiment of FIG. 10, showing a switch assembly.

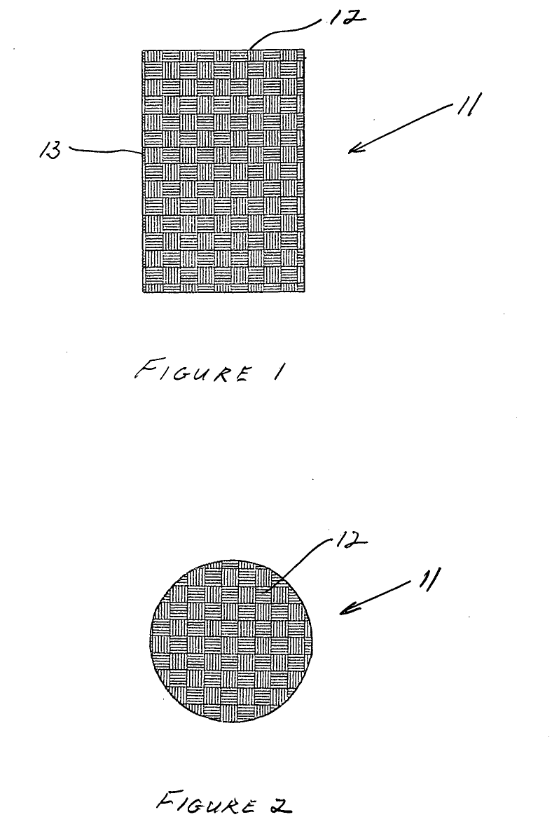

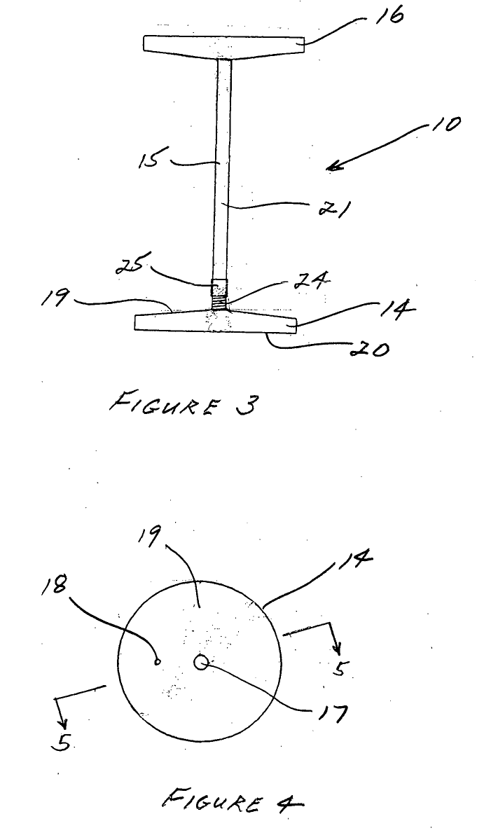

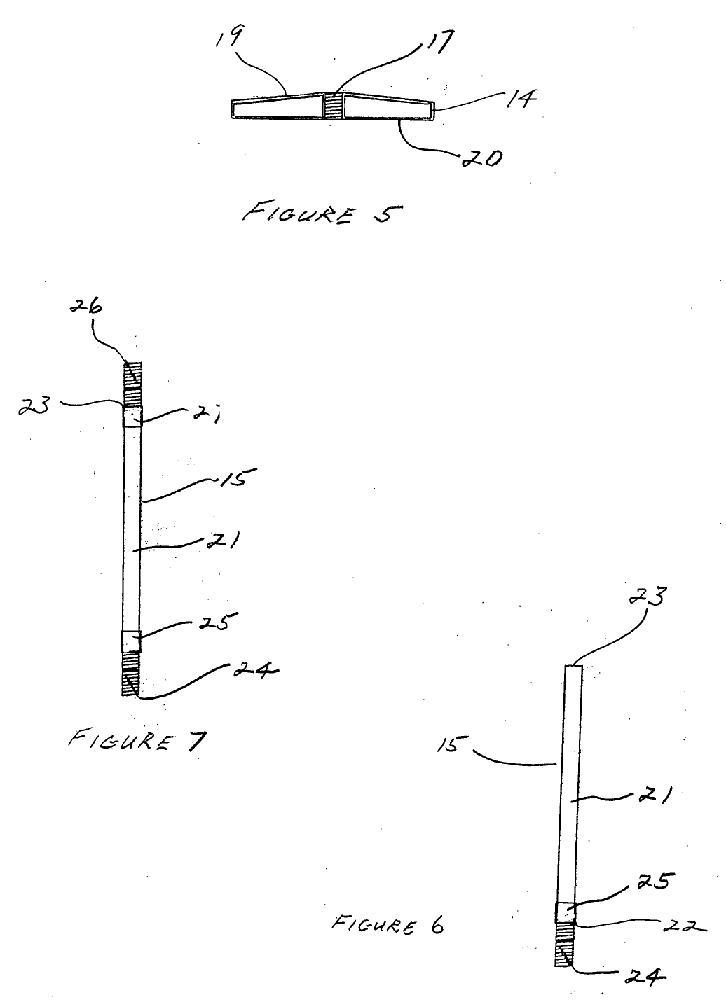

### DESCRIPTION OF THE INVENTION

The retractable barrel of the invention generally comprises an internal support assembly, referred to by reference numeral 10, and a flexible cover 11 disposed over the support assembly. Cover 11 is preferably formed in a cylindrical configuration, with a top 12 and a side wall, or skirt, 13 extending downward from the top in perpendicular relation. The bottom of the cover structure is preferably open so that the cover can be easily placed over the support assembly to provide a free standing retractable barrel with a cylindrical configuration which, in the preferred embodiment, replicates the shape and size of a 55 gallon drum. The cover is preferably formed of a fabric material, such as a heavy canvas, that is sufficiently stiff that the cover will not readily move or flap in a breeze, but is sufficiently flexible that it will easily move upon impact. The cover may be fabricated by stitching the skirt 12 to the top piece 12, but it should be understood that other means of fabrication may be used within the scope of the invention.

Support assembly 10 generally comprises a base 14, an elongate support member 15, and a cover support 16. Base 14 is preferably a disk-shaped body with a diameter approximately equal to, but not larger than, the diameter of the top of the cover. The base is penetrated by a central aperture 17 to receive one end of support member 15 therein. In the preferred embodiment the base is hollow, and includes a closeable filler aperture 18 in its upper surface 19 so that the hollow base can be filled with water to increase the mass of the base, and then emptied when desired to facilitate transportation and storage. In the preferred embodiment the bottom surface 20 of the base is flat, for stability, and the upper surface 19 is inclined so that the base increases in thickness from the outer edge toward the central aperture. It should be understood that although the disk-shaped configuration of the base is preferred, a variety of other configurations could be used within the scope of the invention. It should also be understood that the base could be formed of a solid heavy material, such as concrete or steel, but the use of such a solid base construction would negate the advantages of the lightweight fillable base of the preferred embodiment.

Support member 15 includes a substantially rigid center section 21 with a lower end 22 and an upper end 23, and a spring 24 connected to and extending outwardly from the lower end 22. In the preferred embodiment the center section is formed of a piece of PVC tubing or pipe, and the spring is a coil spring. The spring may be connected to the center section of the support member by collar 25, comprising a short open-ended cylinder, one end of which extends over the outer surface of the end of the central section and is attached thereto by glue or other suitable fastening means. A portion of spring 24 is securely connected within the collar, with the spring extending outwardly therefrom. Collar 25 may be provided with interior threads matching the helical spiral of the coil spring 24, or the spring may be secured by other means such as glue, so long as a reasonably secure connection between those components is achieved and will be maintained during lateral movement of the center section.

The support member 15 is attached to the base 14 by inserting the outer end of spring 24 into the central aperture 17 in the base, so that the support member extends upwardly from the base with the longitudinal axis of the support member perpendicular to the bottom surface of the base. It is preferred that the central aperture 17 be threaded to match the spiral of spring 24, so that a secure connection between the support member and the base is made, but alternative means of connecting the spring within the central aperture of the base may be employed. The length of the spring is such that an unconstrained portion of the spring extends between the base and the collar, so that when lateral force is applied to the support member above the spring, the spring will flex in response to the force and allow the support member to deflect from its rest position. When the force is removed, the spring will return the support member to the original rest position. In the preferred embodiment the spring is relatively stiff, so that the structure of the fully assembled barrel will remain stable and stationary until it is struck by a horse or rider.

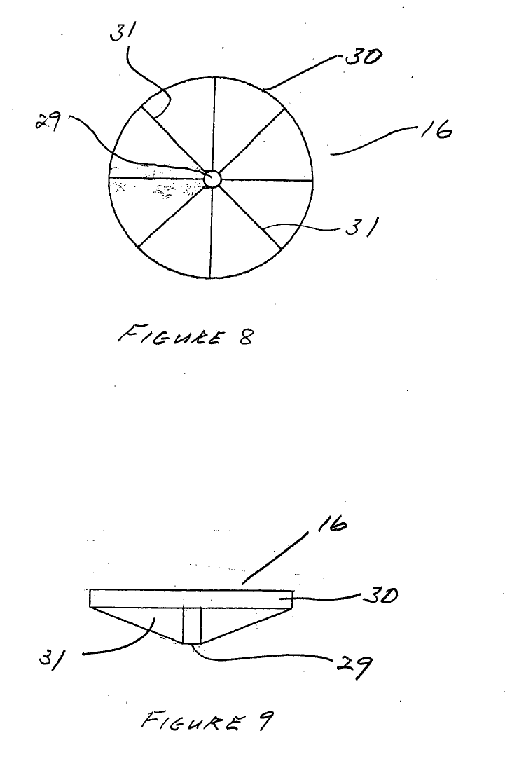

In an alternative embodiment, illustrated in FIG. 7 an upper spring 26 and an upper collar 27 are provided, for forming a flexible connection between the upper end of support member 15 and cover support 16, mirroring the spring and collar arrangement at the lower end of the support member. In both the preferred embodiment and this alternative embodiment the cover support includes a central cover aperture 28, to receive the upper end of the support member. Connection between the upper spring 26 and the upper collar 27, and between the upper spring and the central cover aperture 28 may be made in the same manner as connections between similar components described above for the preferred embodiment.

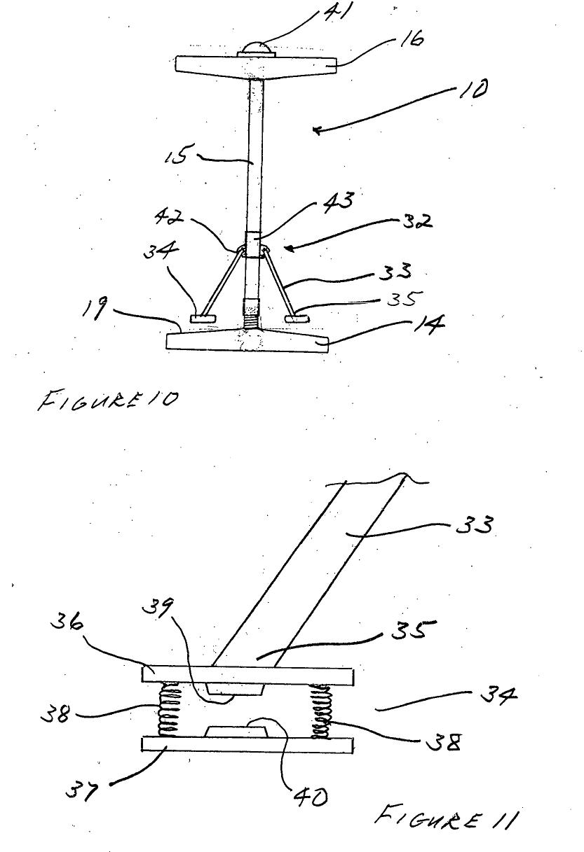

For simplicity and economy of manufacture, it is preferred that cover support 16 of the support assembly, which is connected to the upper end of support member 15 in parallel relation to the base, be identical to the preferred embodiment of the base component. The lightweight, hollow construction of the base makes that component, without the addition of water, a very suitable cover support when connected to the support member in a mirrored relationship to the component used as the base, with the flat surface 20 of that component facing upward. It is to be understood however, that any alternative cover support construction could just as readily be used, so long as the support may be connected to the support member in coaxial relationship to that member and to the base component, and provides an upper face to receive and support the top section of the cover in a flat orientation. For example, an alternative cover support comprising a spoked, wheel-like construction as illustrated in FIGS. 8 and 9 may be utilized. The illustrated alternative cover support includes a central tubular axle 29 to receive the upper end of support member 15, an outer rim 30 concentrically disposed relative to the axle, and a plurality of spokes 31 connected between the axle and the outer rim.

When the support assembly components are connected as described, the cover is placed over it, with the top of the cover supported by the cover support component and the cover skirt hanging freely to the ground, completing the assembly of the barrel apparatus of the invention and readying it for use. The barrel apparatus of the invention has the same appearance as a rigid barrel and is placed and used in the same way. If a horse and rider successfully negotiate the course without striking a barrel, they experience no difference between the barrel apparatus of the invention and a conventional rigid steel barrel. However, if the horse comes too close to one of the barrel apparatus and hits the outer edge of the cover support of the barrel itself or causes the rider's leg to strike the cover support, the lateral force will cause spring 24, or both springs 24 and 26 of the alternative embodiment, to flex and the cover support to move away from the impact, or retract, with much less inertia than would be exhibited by a rigid barrel. The resilience of the training barrel structure, compared to the rigidity of a conventional barrel, substantially reduces the effect of the impact on the horse and/or rider and correspondingly reduces the probability of injury. Further, the barrel apparatus of the invention is much less likely to overturn in response to a tangential impact than a conventional barrel, but the cover support and support member will flex out of the way and return to their rest position without moving the base, eliminating the need to reset the barrel before the course can be run again.

In the event of a more direct collision between horse and a conventional barrel, the rigid barrel will overturn, often into the direct path of the horse, causing the horse to fall over, or onto, the barrel, creating a highly dangerous situation in which injury to both horse and rider is likely to occur. If a horse directly collides with the barrel apparatus of the invention, however, the spring, or springs, connecting the support member to the base and cover support will flex, allowing the barrel structure to retract completely to the ground, substantially reducing the impediment to the movement of the horse posed by a conventional barrel and greatly reducing the possibility that the horse will fall.

Another dangerous situation that arises with the use of conventional barrels in barrel racing and training is one in which the rider falls from the horse while the horse is circling a barrel. Because the horse and rider are leaning toward the barrel during that maneuver, a fallen rider will often fall onto the barrel itself and may sustain serious body and/or head injury. If a rider falls onto a barrel of the invention, however, the barrel structure will retract, or collapse, to the ground under the weight of the rider, absorbing much of the impact force and carrying the rider to the ground. Retraction of the barrel of the invention eliminates the concentrated forces upon the rider's body resulting from impact with sharp edges and rigid structure of a conventional barrel, and substantially reduces the possibility of injury.

The structure and resulting features of the barrel apparatus of the invention make it extremely useful and beneficial in training programs. However, the reduced likelihood that a barrel apparatus as described above will overturn as the result of an impact, although beneficial in most respects, presents a problem in barrel racing competition. In barrel racing competitions, if a horse and rider knock over a barrel a penalty is accessed. In order to create the same level of difficulty for competitors and maintain consistency in competitive conditions, the barrel apparatus of the invention may be provided with a sensing and signal means, to sense a lateral deflection that would result in overturning a conventional barrel and signal the fault so that an appropriate penalty can be assessed.

An embodiment of the apparatus of the invention with a sensing and signaling means, generally designated by reference number 32, is illustrated in FIGS. 10 and 11. In the illustrated embodiment, the signaling and sensing means includes a plurality of legs 33 that extend outwardly from support member 15 toward base 14 at an angle relative to the support member. The legs should be disposed symmetrically around the support member, and the number of legs should be sufficient to assure activation regardless of the direction of deflection. A switch assembly 34 is disposed at the outer end 35of each leg, for the purpose of closing a switch and completing an electrical circuit when support member 15 is deflected sufficiently to bring the switch assembly into contact with the upper surface of the base. As shown in FIG. 11, each switch assembly includes an fixed contact plate 36 securely connected to the outer end of the leg 33, a moveable contact plate 37 separated from the fixed plate. Springs 38 are disposed between the fixed and moveable plates, to allow the moveable plate to move toward the fixed plate when force is applied to the moveable plate. Aligned electrical contacts 39 and 40 are provided on the fixed and moveable plates, respectively. The electrical contacts are held in separated relation by springs 38 until contact of moveable plate 37 against base 14 forces the moveable plate toward the fixed plate and brings electrical contacts 39 and 40 together, completing an electrical circuit and activating a signal. The switch assembly may be enclosed within a flexible boot or other protection, to exclude dirt that might interfere with electrical contact. It is to be understood that the structure of the switch assembly is susceptible to variation, and other designs may be used within the scope of the invention. It is preferred that the sensing and signaling means be battery powered.

As shown in FIG. 10, the signal activated by the operation of any of the switch assemblies comprises a light 41 mounted on the upper surface of cover support 16. An opening maybe formed in cover 11 to fit over the light so the light can be easily seen. Instead of, or in addition to, a light to indicate that the barrel apparatus has been tilted sufficiently to constitute a fault, an audible signal or an electronic signal may be used. An electronic signal may be a radio frequency signal to a remote receiver that could trigger a variety of responses, including a visual signal, an audible signal, or an automatic increase in the time recorded by an electronic timing device.

In the mechanical structure of the sensing and signaling means, it is preferred that legs 33 be pivotally connected to support member 15, so that the legs are allowed to pivot after contact with the base of the apparatus and will not compromise safety by impeding the flexibility of the barrel structure. It is also preferred that the legs be adjustable along support member 15, so that the distance between the switch assemblies and the base of the apparatus, and thus the degree of deflection required to activate a signal, can be adjusted. In the illustrated embodiment, the upper or inner ends 42 of legs 33 are pivotally connected to sleeve 43 that surrounds support member 15 and is adjustably connectable thereto.

The foregoing description of the preferred and various alternative embodiments of the invention is intended to be illustrative and not limiting of the scope of the invention. The invention is susceptible to additional alternative embodiments and variations within the scope of the invention.

1. A retractable barrel apparatus comprising
a base;
an elongate support member having first and second ends and having a longitudinal axis, said elongate support member flexibly interconnected at said first end to said base;
a cover support having a substantially flat upper face, a generally circular perimeter edge, and a central axis, said cover support interconnected to said second end of said elongate support member in coaxial alignment therewith, with said upper face of said cover support generally perpendicular to said longitudinal axis of said elongate support member; and
a cover, formed of a flexible material, disposed on said cover support, said cover having a side wall extending around said perimeter edge of said cover support and extending therefrom toward said base in generally perpendicular relation to said upper face of said cover support, such that said wall surrounds said elongate support member.
